(19) United States
(12) Patent Application Publication
(10) Pub. No.: US 2019/0343119 A1
(43) Pub. Date: Nov. 14, 2019

(54) INSECT REPELLENT PRODUCT

(71) Applicant: Zobele Holding S.P.A., Trento (IT)

(72) Inventors: Montserrat Riera Giner, Barcelona (ES); Joaquim Liorente Alonso, Barcelona (ES); Jorge Alejandro Martinez Uribe, Barcelona (ES)

(21) Appl. No.: 16/473,927

(22) PCT Filed: Dec. 19, 2017
(86) PCT No.: PCT/EP2017/083497

§ 371 Date: Jun. 26, 2019

(30) Foreign Application Priority Data
Dec. 28, 2016 (ES) P201631696

(51) Int. Cl. A01N 43/08; A01N 65/28; A01N 65/44; A01N 65/22; A01N 65/36

(52) U.S. Cl. CPC A01N 43/08; A01N 65/28; A01N 65/36; A01N 65/22; A01N 65/44

(57) ABSTRACT

The invention relates to an insect repellent product comprising a mixture of a plurality of essential oils and at least one secondary compound. Said essential oils are chosen from the essential oils of eucalyptus, citronella, lavandin, rosemary, lemon and undecalactone, or a mixture of the same, and said at least one secondary compound is chosen from citral, linalool, citronellal, geraniol, and geranyl acetate.

It provides a natural, biodegradable and long-lasting insect repellent.

The present invention relates to an insect repellent product that prevents insect bites by continuously releasing volatile substances into the air, in addition to releasing a pleasant odor which is used as an air-freshener.

### BACKGROUND OF THE INVENTION

Many insect repellents that are referred to as natural, the basis of which is made up of essential oils, are currently known. These formulations are based on products with insect repellent capabilities that substitute traditional chemical products.

These repellents are usually marketed as lotions, creams or aerosols that are applied to the user's skin and/or clothes. Aerosols and lotions are absorbed by the skin, directly exposing the user to the same chemical substances that are intended to protect them from insects, possibly resulting in physical allergic reactions or other types of reactions, skin irritation and damage to fabrics or other materials and they leave an unpleasant oily layer.

Furthermore, the majority of the essential oils used in these products are highly volatile, meaning they have a short longevity and making them poor insect repellents. They can last on the skin for a relatively short time period (such as 4 hours) and thus must be applied again after said period in order to provide continuous protection over a longer period of time.

Another way of releasing insect repellent products is through patches and wristbands. Patches and wristbands with these types of repellents also have direct contact with the user's skin and are limited as to where they can be used. Moreover, adhesive wristbands and patches have a limited amount of the product, and additional application thereof is not possible.

The technique of using candles, for example of citronella and geraniol, is also known. However, it has been proven that citronella and geraniol are not very effective insect repellents, even when release into the air through a candle.

Therefore, nowadays there is no insect repellent on the market that is natural, biodegradable and long-lasting.

### DESCRIPTION OF THE INVENTION

The insect repellent product of the invention solves the aforementioned drawbacks and has other advantages which are described below.

The insect repellent product according to the present invention is characterized in that it comprises a mixture of a plurality of essential oils and, preferably, further comprises at least one secondary compound.

Advantageously, said essential oils are chosen from the essential oils of eucalyptus, citronella, lavandin, rosemary, lemon and undecalactone, or a mixture of the same, and said at least one secondary compound is chosen from citral, linalool, citronellal, geraniol, and geranyl acetate.

In addition, the insect repellent product according to the present invention may also comprise at least one solvent, at least one ultraviolet light absorbent, stabilizers and/or antioxidants.

If the user desires, the insect repellent product can be dissolved in a carrier fluid, such as dipropylene glycol methyl ether, or impregnated in porous medium.

The insect repellent product according to the present invention has the main advantage in that it can be released into the air in a continuous way, and at the same time release a pleasant and unique odor that freshens up the air.

Furthermore, it is suitable for being applied through liquid diffusers that can be plugged in, diffusers using tablets, coils or other types of diffusers (such as wick diffusers).

To reinforce the prevention of insect bites, some identical natural components may be added, cited as additional components. The so-called identical natural components are compounds that can be found in the aforementioned essential oils. An example of such components could be: citral, linalool, alpha-pinene, beta-pinene, citronellal, geraniol, geranyl acetate, among others.

### DESCRIPTION OF PREFERRED EMBODIMENTS

The present invention relates to an insect repellent product with a composition that can be released into the air in a continuous way and at the same time release a pleasant and unique odor that freshens up the air.

In nature, plants commonly produce volatile compounds, or essential oils, when their leaves are damaged, with the aim of deterring herbivores. When these volatile substances are joined to the odorant receptor proteins that are exposed to the exterior environment, such as on insect antennae, they block the insect's ability to locate the host.

Each volatile compound of the essential oil produces a different response, and a suitable combination of the volatile compounds reduces or even blocks insects and prevents them from biting.

The formulation of the insect repellent product according to the present invention includes a main composition that comprises at least one of the essential oils of eucalyptus, citronella, lavandin, rosemary, lemon and undecalactone in order to provide a preventive effect against insect bites.

Furthermore, in said formulation, at least one of a series of secondary components is added (for example, citral, linalool, citronellal, geraniol, geranyl acetate) that provides an additional beneficial characteristic.

The eucalyptus oil that can be used in the composition is a volatile oil extracted from the fresh leaves of a specific eucalyptus species (such as Eucalyptus citriodora and Eucalyptus globulus). The main components thereof are limonene, 1.8 cineol and citral.

The main source of citronella essential oil is Cymbopogon nardus. Citronella mainly comprises citronellal, citronellol, geraniol, citral, alpha-pinene and limonene.

To obtain the essential oils of lavandin, the most common species used is Lavandula X intermedia, a hybrid of Lavandula angustifolia and Lavandula latifolia. 1.8-cineol, borneol and camphor are the main compositions of the essential oil of lavandin.

Rosemary extract is produced by Rosmarinus officinalis or Rosmarinus coronarium from the family Lamiaceae. The main components are 1.8 cineol and alpha-pinene.

Lemon oil is obtained by cold pressing the peel of the lemon citrus fruit. The main chemical components of lemon oil are alpha-pinene, camphene, beta-pinene, sabinene, myrcene, alpha-terpinene, linalool, beta-bisabolene, limonene, trans-alpha-bergamotene, nerol and neral.

To reinforce the prevention of insect bites, some components may be added to the formula. These components are mainly citral and linalool. Alternatively, alpha-pinene, beta-pinene, citronellal, geraniol and geranyl acetate can be added.

For example, the essential oil of citronella can be used in concentrations, by weight, of 3 to 15%, and more preferably in concentrations by weight of 5 to 10%; the essential oils of eucalyptus can be used in concentrations, by weight, of 0.5 to 8%, and more preferably in concentrations by weight of 1 to 5%; the essential oil of lavandin can be used in concentrations by weight of 0.5 to 8% and more preferably in concentrations by weight of 0.5 to 3%; the essential oil of rosemary can be used in concentrations, by weight, of 0.1 to 5%, and more preferably in concentrations of 0.2 to 2%.

Preferably, the total concentration of essential oils in the formulation of the insect repellent product can vary from 10 to 20% by weight.

The formulation can also include undecalactone. This chemical substance can be found in tomato leaf extracts. Undecalactone is added in a concentration by weight of 0.1 to 5% and more preferably in concentrations of 0.5 to 3%.

The secondary components that can be added to the formula for reinforcing the prevention of bites are citral, linalool, citronellal, geraniol and geranyl acetate. These secondary components can be added at an interval of 0 to 20%.

For also using the insect repellent product as an air-freshener, the same may comprise one or more solvents. The standard solvents used in the insect repellent product of the present invention are glycol ethers, such as dipropylene glycol dimethyl ether, dipropylene glycol methyl ether, and tripropylene glycol methyl ether to control the evaporation rate. Other solvents such as isopropyl palmitate or isopropyl myristate, or any other suitable solvent, can also be used.

UV absorbents or UV stabilizers may also be added to protect the oils from the potential harmful effects of sunlight. Some useful UV absorbents or stabilizers are benzophenone, salicylate esters or similar.

The insect repellent product according to the present invention may also include a carrier fluid, such as dipropylene glycol methyl ether in a quantity of 5 to 50% by weight, preferably of 10 to 25% by weight, to create an insect repellent product to be diffused through a wick diffuser.

Described below are some non-limiting examples of the insect repellent product according to the present invention.

It must be mentioned that the term “active formula” refers to the main mixture of the composition (essential oils) and to the secondary components (citral, linalool, citronellal, geraniol and/or geranyl acetate), as indicated in each example. Moreover, the percentages are by weight, unless indicated otherwise.

### Example 1

active formula 17%
Butylated hydroxytoluene (BHT) 1%
dipropylene glycol methyl ether 82%

### Active Formula Composition:

| Substance | CAS | % w/w |
|---|---|---|
| Citronella oil | 91771-61-8 | 8.0 |
| Eucalyptus oil | 84626-32-1 | 3.0 |
| Lavandin oil | 91722-69-9 | 1.0 |
| Rosemary oil | 84604-14-8/O | 0.8 |
| Lemon oil | 8008-56-8 | 0.1 |
| Citral | 55392-40-5 | 23.00 |
| Linalool | 78-70-6 | 37.613 |

A bottle with 30 ml of said formula is used. A cylindrical wick made from wood is used to transport the volatile substance from the bottle to the vicinity of an electric heater. The bottle is used inside an electric diffuser that is plugged into the electrical grid, which causes the evaporation of the volatile substances.

### Efficiency Test:

The product was activated in a 20 m³ test chamber. The product was left for a specific time period (from 1 to 2 hours), in order to allow enough time for the product to create an active atmosphere. Mosquitos were then released in the same chamber (50 female mosquitos approximately 7 days old, released 5 minutes before the beginning of the evaluation). A human volunteer with their forearms and legs exposed entered the chamber and closed the entrance door. The volunteer stayed in the chamber for a maximum of 15 minutes, each volunteer entering 1 hour after the product was activated and 2 hours after the product was activated. The amount of mosquito bites was counted. If the volunteer received 5 bites before the maximum test time of 15 minutes was up, the test was stopped to prevent the volunteer from receiving excessive mosquito bites. The mosquitos were subsequently removed from the chamber. For each test a new batch of 50 female mosquitoes was released into the chamber. After each test, all of the mosquitos were removed from the chambers. The mosquitoes used had not bitten before the test, which means that they were motivated to bite and consume the blood of the human host.

Controls for comparison without treatment were carried out before beginning the test, in order to verify that the mosquitoes were biting in a normal way. An identical test was performed without the product. The time was measured up until there was a total of 5 bites. The minimum amount of mosquito bites allowed on the arms/legs of the subject was 5 mosquito bites in 10 minutes. This way is was possible to verify that the mosquitoes demonstrated a sufficient biting activity. If there were fewer bites in 10 minutes, the test would not have taken place.

After 2 hours of prior conditioning, the product according to the present invention had a preventative effectiveness of 100% against mosquito bites for both volunteers during the 15 minutes of testing (0 bites in 15 minutes).

The controls without treatment (5 bites in 10 minutes), which tested the biting activity of the mosquitoes, resulted in 5 mosquito bites in 3 minutes and 43 seconds (volunteer 1) and 5 minutes and 42 seconds (volunteer 2).

The product of the present invention can also be used in the composition of an insecticide tablet, comprising a solvent and a porous medium, which forms the tablet. The standard solvents used in the present invention are glycol ethers, such as dipropylene glycol dimethyl ether, dipropylene glycol methyl ether, tripropylene glycol methyl ether, tripropylene glycol n-butyl ether to control the evaporation rate. Other solvents, such as isopropyl palmitate or isopropyl myristate, or other suitable solvents, can also be used.

Furthermore, the porous medium formed by the tablet can be a fibrillar substrate, such as cellulose, although any porous material that can contain a volatile substance may be used, such as a substrate of synthetic polymer fibers, open-cell foam or any other material.

### Example 2

A 2.5 mm thick cellulose tablet was used, impregnated with 520 mg of the following composition:
active formula 50%
tripropylene glycol methyl ether 40%
tripropylene glycol n-butyl ether 10%

### Active Formula Composition:

| Substance | CAS | % w/w |
|---|---|---|
| Citronella oil | 91771-61-8 | 8.0 |
| Eucalyptus oil | 84626-32-1 | 3.0 |
| Lavandin oil | 91722-69-9 | 1.0 |
| Rosemary oil | 84604-14-8/O | 0.8 |
| Lemon oil | 8008-56-8 | 0.1 |
| Citral | 55392-40-5 | 23.00 |
| Linalool | 78-70-6 | 37.613 |

This tablet, impregnated with the formulation, was placed on a conventional hot plate and in an insecticide dispenser apparatus.

### Efficiency Test:

The test protocol was similar to that of example 1: The product was activated in a 20 m³ test chamber. The product was left for a specific time period (from 1 to 2 hours) in order to allow the product to create an active atmosphere. Mosquitos Culex quinquefasciatus Say were then released in the same chamber that contained the product (50 female mosquitos approximately 7 days old, released 5 minutes before the beginning of the evaluation). A human volunteer with their forearms and legs exposed entered the chamber and closed the entrance door. The volunteer stayed in the chamber for a maximum of 15 minutes, entering 1 hour after the product was activated and 2 hours after the product was activated. The amount of mosquito bites was counted. If the volunteer received 5 bites before the maximum test time of 15 minutes was up, the test was stopped to prevent the volunteer from receiving excessive mosquito bites. The mosquitos were subsequently removed from the chamber. For each test a new batch of 50 female mosquitoes was released into the chamber. After each test, all of the mosquitos were removed from the chambers. The mosquitoes used had not bitten before the test, which means that they were motivated to bite and consume the blood of the human host.

Controls for comparison without treatment were carried out before beginning the test to verify that the mosquitoes were biting in a normal way. An identical test was performed without the product. The time was measured up until there was a total of 5 bites. The minimum amount of mosquito bites allowed on the arms/legs of the subject was 5 mosquito bites in 10 minutes. This way, it was possible to verify that the mosquitoes demonstrated a sufficient biting activity. If there were fewer bites in 10 minutes, the test would not have taken place.

Results with the Product According to the Invention:

Volunteer 1: 3 bites in 10 minutes

Volunteer 2: 2 bites in 10 minutes

Volunteer 3: 1 bite in 10 minutes

Results of the Control Test without any Product:

Volunteer 1: 5 bites in 1 minute and 34 seconds

Volunteer 2: 5 bites in 2 minutes and 6 seconds

Although the results were not as good as in example 1, it was demonstrated that formulation nonetheless reduced the biting activity of the mosquitoes.

Despite the fact that reference has been made to a specific embodiment of the invention, it is evident for a person skilled in the art that numerous variations and changes may be made to the insect repellent product described, and that all the aforementioned details may be substituted by other technically equivalent ones, without detracting from the scope of protection defined by the attached claims.

What is claimed is:

1. An insect repellent product comprising an essential oil, the insect repellant product further comprising a mixture of a plurality of essential oils.

2. The insect repellent product according to claim 1, further comprising at least a secondary compound.

3. The insect repellent product according to claim 1, wherein said essential oils are chosen among the essential oils of eucalyptus, citronella, lavandin, rosemary, lemon and undecalactone, or a mixture of the same.

4. The insect repellent product according to claim 2, wherein said at least one secondary compound is chosen from citral, linalool, citronellal, geraniol and geranyl acetate.

5. The insect repellent product according to claim 1, further comprising at least a solvent.

6. The insect repellent product according to claim 1, further comprising at least an ultraviolet light absorbent.

7. The insect repellent product according to claim 1, further comprising stabilizers.

8. The insect repellent product according to claim 1, further comprising antioxidants.

9. The insect repellent product according to claim 1, which is dissolved in a carrier fluid.

10. The insect repellent product according to claim 1, which is impregnated in a porous medium.

11. The insect repellent product according to claim 9, wherein said carrier fluid is dipropylene glycol methyl ether.
